(19) United States
(12) Patent Application Publication
(10) Pub. No.: US 2025/0086996 A1
(43) Pub. Date: Mar. 13, 2025

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventors: Ryoma OUCHI, Tokyo (JP); Makoto TERAO, Tokyo (JP); Shuhei YOSHIDA, Tokyo (JP)

(73) Assignee: NEC Corporation, Minato-ku, Tokyo (JP)

(21) Appl. No.: 18/723,909

(22) PCT Filed: Mar. 2, 2022
(86) PCT No.: PCT/JP2022/008717

§ 371 Date: Jun. 25, 2024

(51) Int. Cl. G06V 20/70; G06V 10/764; G06V 10/774; G06V 40/20

(52) U.S. Cl. CPC G06V 20/70; G06V 10/764; G06V 10/774; G06V 40/20

(57) ABSTRACT

In order to solve a problem of making it possible to provide a technique by which assigning a pseudo label is possible regardless of the presence or absence of class-labeled data, an information processing apparatus 1 includes: an inferring means (11) for inferring a class regarding data pieces which constitute time-series data; a calculating means (12) for calculating a degree of agreement among results of inference made by the inferring means regarding a plurality of data pieces contained in a section which is temporally continuous; and a pseudo label assigning means (13) for assigning a pseudo label based on the results of inference in the section, to at least one of the plurality of data pieces in the section, according to the degree of agreement.

### TECHNICAL FIELD

The present invention relates to an information processing apparatus, an information processing method, and a program each of which is capable of assigning a pseudo label regardless of the presence or absence of class-labeled data.

### BACKGROUND ART

In training an AI model with use of labeled training data, the cost of collecting data becomes a burden. In order to reduce the cost of collecting labeled training data, a weak-label method of attaching a label only to part of data to prepare labeled training data has conventionally been used.

For example, in a case where behavior recognition is performed with respect to moving image data consisting of consecutive frames, there is demand for reducing the cost of training an AI model by attaching a label only to a subset of time-series data.

Further, a method of attaching a pseudo label to unlabeled data to train an AI model has also been proposed (see, for example, Non-Patent Literature 1). According to Non-Patent Literature 1, the class of data close to class-labeled data is predicted, and a pseudo label is attached on the basis of the result of the prediction.

### CITATION LIST

### Non-Patent Literature

[Non-patent Literature 1]
SF-Net: Single-Frame Supervision for Temporal Action Localization aXiv: 2003.06845

### SUMMARY OF INVENTION

### Technical Problem

However, with the technique disclosed in Non-Patent Literature 1, the improvement in inference accuracy is limited because the data to be assigned a pseudo label is limited to data close in time to class-labeled data. For example, in a case of time-series data of long duration, it is possible to assign a pseudo label only to part of the time-series data. In addition, there is a problem of being impossible to use, for training, data close in time to data which does not have a class label assigned thereto.

An example aspect of the present invention has been made in view of the above problems, and an example object thereof is to make it possible to provide a technique by which assigning a pseudo label is possible regardless of the presence or absence of class-labeled data.

### Solution to Problem

An information processing apparatus in accordance with an example aspect of the present invention includes: an inferring means for inferring a class regarding each of data pieces which constitute time-series data; a calculating means for calculating a degree of agreement among results of inference made by the inferring means regarding a plurality of data pieces contained in a section which is temporally continuous; and a pseudo label assigning means for assigning a pseudo label based on the results of inference in the section, to at least one of the plurality of data pieces in the section, according to the degree of agreement.

An information processing method in accordance with an example aspect of the present invention includes: inferring a class regarding each of data pieces which constitute time-series data; calculating a degree of agreement among results of inference regarding a plurality of data pieces which are contained in a section which is temporally continuous; and assigning a pseudo label based on the results of inference in the section, to at least one of the plurality of data pieces in the section, according to the degree of agreement.

A program in accordance with an example aspect of the present invention causes a computer to function as an information processing apparatus including: an inferring means for inferring a class regarding each of data pieces which constitute time-series data; a calculating means for calculating a degree of agreement among results of inference made by the inferring means regarding a plurality of data pieces contained in a section which is temporally continuous; and a pseudo label assigning means for assigning a pseudo label based on the results of inference in the section, to at least one of the plurality of data pieces in the section, according to the degree of agreement.

### Advantageous Effects of Invention

With an example aspect of the present invention, it is possible to provide a technique by which assigning a pseudo label is possible regardless of the presence or absence of class-labeled data.

### BRIEF DESCRIPTION OF DRAWINGS

FIG. 1 is a block diagram illustrating an example configuration of information processing in accordance with a first example embodiment of the present invention.

FIG. 2 is a representation for explaining the function of each of the sections of the information processing apparatus of FIG. 1.

FIG. 3 is a flowchart illustrating a flow of an information processing method in accordance with the first example embodiment of the present invention.

FIG. 4 is a block diagram illustrating an example configuration of an information processing apparatus in accordance with a second example embodiment of the present invention.

FIG. 5 is a flowchart illustrating a flow of an information processing method in accordance with the second example embodiment of the present invention.

FIG. 6 is a representation for explaining the dispersion in the highest degrees of confidence (maximum degrees of confidence) in the results of inference of data pieces.

FIG. 7 is a flowchart illustrating a flow of an information processing method in accordance with a third example embodiment of the present invention.

FIG. 8 is a diagram illustrating an example configuration of a computer which carries out the instructions of a program which is software for implementing each of the functions.

### EXAMPLE EMBODIMENTS

### First Example Embodiment

The following description will discuss a first example embodiment of the present invention in detail, with reference to the drawings. The present example embodiment is basic to example embodiments which will be described later.

### <Outline of Information Processing Apparatus 1>

In brief, an information processing apparatus 1 in accordance with the present example embodiment is an apparatus for assigning a pseudo label to a data piece of time-series data.

As an example, the information processing apparatus 1 includes:
an inferring means for inferring a class regarding each of data pieces which constitute time-series data;
a calculating means for calculating a degree of agreement among results of inference made by the inferring means regarding a plurality of data pieces contained in a section which is temporally continuous; and
a pseudo label assigning means for assigning a pseudo label based on the results of inference in the section, to at least one of the plurality of data pieces in the section, according to the degree of agreement.

### <Configuration of Information Processing Apparatus 1>

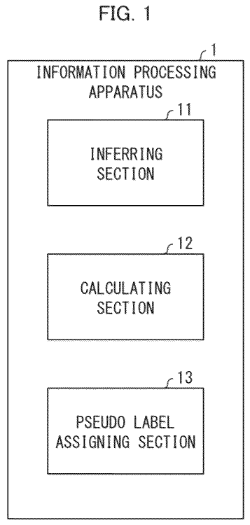

Here is a description of a configuration of an information processing apparatus 1 in accordance with the present example embodiment, provided with reference to FIG. 1. FIG. 1 is a block diagram illustrating an example configuration of the information processing apparatus 1.

The information processing apparatus 1 includes an inferring section 11, a calculating section 12, and a pseudo label assigning section 13, as illustrated in FIG. 1. The inferring section 11 is a component for providing the inferring means in the present example embodiment. The calculating section 12 is a component for providing the calculating means in the present example embodiment. The pseudo label assigning section 13 is a component for providing the pseudo label assigning means in the present example embodiment.

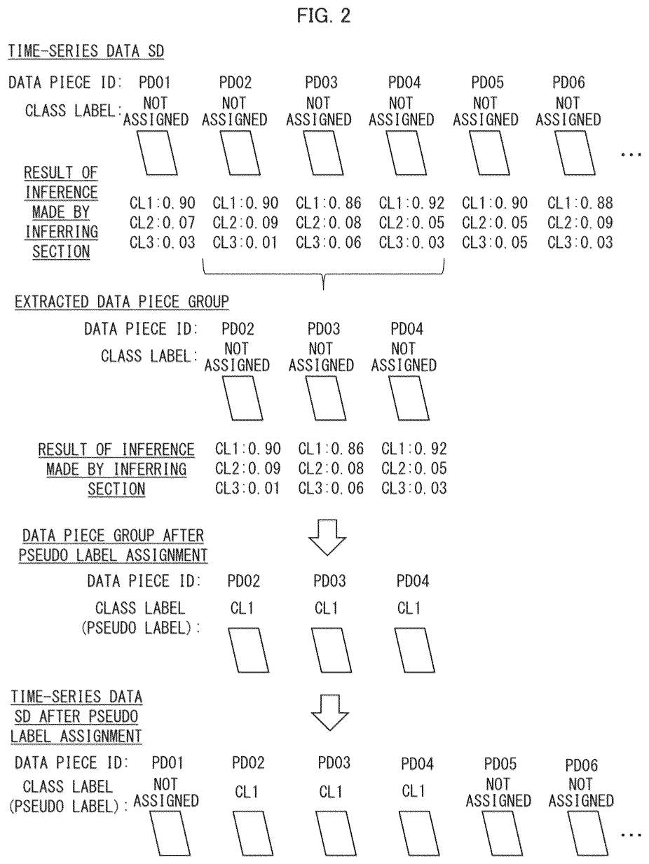

The inferring section 11 infers a class of inputted data with use of an inference model. The calculating section 12 calculates the degree of agreement regarding results of inference outputted by the inferring section 11. The pseudo label assigning section 13 assigns a pseudo label to the inputted data with reference to the result of the calculation carried out by the calculating section 12. With reference to FIG. 2, the function of each of the sections of the information processing apparatus 1 is described below in more detail.

FIG. 2 is a representation for explaining the function of each of the sections of the information processing apparatus 1 of FIG. 1. Assume that, in this example, time-series data SD is inputted to the information processing apparatus 1. As an example, the time-series data is moving image data consisting of pieces of data which are temporally consecutive frames.

The time-series data illustrated in FIG. 2 includes data pieces. As an example, each of the data pieces is data which is a frame contained in moving image data. In the example of FIG. 2, each data piece has a data piece ID attached thereto, and data piece IDs which are PD01, PD02, PD03, PD04, PD05, and PD06 are attached. In the following description, a data piece having the data piece ID attached thereto is referred to as the data piece PD01, the data piece PD02, or the like, where appropriate.

The data piece PD01 to the data piece PD06 do not have class labels assigned thereto. Therefore, the class label “not assigned” is illustrated in FIG. 2.

The inferring section 11 infers a class regarding each of data pieces which constitute the time-series data. The inferring section 11 infers a class regarding each data piece with use of an inference model composed of model parameters and operational expressions.

As an example, the time-series data is moving image data. In this case, the inferring section 11 infers an action (e.g. walking, sitting, etc.) of the subject in each of the frames which constitute moving images. The action is a class.

In the example of FIG. 2, results of inference made by the inferring section 11 are illustrated. The inferring section 11 infers the class of each of the data pieces, and outputs scores which represent probabilities that each data piece is classified as each of classes which are class 1, class 2, and class 3. For example, in the example of FIG. 2, “CL1: 0.90, CL2: 0.07, CL3: 0.03” are outputted as the result of inferring the class of the data piece PD1.

This result of inference indicates that the probability that the data piece PD1 is classified as class 1 is 0.90, the probability of being classified as class 2 is 0.07, and the probability of being classified as class 3 is 0.03. Note that CL1, CL2, and CL3 mean class 1, class 2, and class 3, respectively, and 0.90 is a score corresponding to class 1, 0.07 is a score corresponding to class 2, and 0.03 is a score corresponding to class 3.

Similarly, the results of inference regarding the data piece PD02 to data piece PD06 of FIG. 2 are also outputted. That is, the degree of confidence in each of the plurality of classes is outputted as the result of inference made by the inferring section 11.

The calculating section 12 extracts a data piece group in a section which is temporally continuous, from the data piece PD01 to the data piece PD06. In the example of FIG. 2, the data piece PD02 to the data piece PD04 are extracted as the data piece group. Since the data piece group extracted in the example has not assigned a class label yet, the class label is indicated as “not assigned”.

The calculating section 12 calculates the degree of agreement among the results of inference regarding the data pieces extracted. As an example, the degree of agreement is calculated on the basis of whether the classes of highest scores in the results of inference agree with each other. In a case of the example of FIG. 2, in the data piece group of the data piece PD02 to the data piece PD04, the classes with highest scores of the data pieces are all class 1. Thus, three out of the three data pieces agree in the class with each other. The degree of agreement is therefore calculated to be 3/3=1.

That is, the calculating section 12 calculates the degree of agreement among the results of inference made by the inferring section 11 regarding a plurality of data pieces contained in a section which is temporally continuous.

The pseudo label assigning section 13 judges whether the degree of agreement among the results of inference among the extracted data pieces satisfies a predetermined condition. In this judgment, for example, whether the degree of agreement calculated by the calculating section 12 is greater than a preset threshold is judged. For example, in a case where the threshold is 0.66 (=⅔), the degree of agreement among the results of inference regarding the data piece group of FIG. 2 is judged to satisfy the predetermined condition.

The pseudo label assigning section 13 assigns a pseudo label to a data piece group having the results of inference the degree of agreement among which is judged to satisfy a predetermined condition. Typically, a label assigned to labeled training data represents the actual class of data, and indicates a class which serves as a ground truth in inferring the class of the data.

On the other hand, a label assigned by the pseudo label assigning section 13 is a result of inference made by the inferring section 11, and does not indicate the actual class of data. Such a label is referred to as a pseudo label. In the example of FIG. 2, as a data piece group after pseudo label assignment, the data piece group of the data piece PD02 to the data piece PD04 are illustrated together with class labels (pseudo labels) thereof. In this example, as the pseudo labels, CL1 representing the class 1 is assigned.

Typically, in a section which is temporally continuous in time-series data, interrelationship is considered to be high. For example, in a section which is temporally continuous in moving images of a person, the person is highly likely to act the same (e.g. walk, sit, etc.). Therefore, when the degree of agreement among the results of class inference regarding each data piece of a data piece group, the results of inference are highly likely to be correct.

The pseudo label assigning section 13 therefore assigns a pseudo label to a data piece group having the results of inference the degree of agreement among which is judged to satisfy a predetermined condition.

Through these processes, time-series data SD after the pseudo label assignment is obtained. Illustrated in the example of FIG. 2 is time-series data SD in which each of the data piece PD01, the data piece PD05, and the data piece PD06 does not has a class label assigned thereto, and each of the data piece PD02 to the data piece PD04 has a class label (pseudo label) assigned thereto.

Note that although all of the data piece PD02 to the data piece PD04, which constitute the data piece group, have pseudo labels assigned thereto in this example, the pseudo label assigning section 13 may assign the pseudo label to some of the data pieces which constitute the data piece group.

In this manner, the pseudo label assigning section 13 assigns a pseudo label based on the results of inference in a section, to at least one of a plurality of data pieces, according to the degree of agreement.

### <Flow of Information Processing Method S1 Carried Out by Information Processing Apparatus 1>

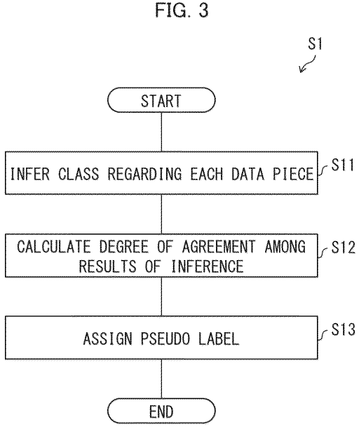

Here is a description of a flow of an information processing method S1 carried out by the information processing apparatus 1 configured as described above, provided with reference to FIG. 3. FIG. 3 is a flowchart illustrating a flow of the information processing method. The information processing includes step S11, step S12, and step S13, as illustrated in FIG. 3.

In step S11, the inferring section 11 infers a class regarding each of the data pieces which constitute time-series data. In this inference, the inferring section 11 infers a class of each of the data pieces, and outputs scores which represent probabilities that each data piece is classified as each of classes which are class 1, class 2, and class 3.

In step S12, the calculating section 12 calculates the degree of agreement among the results of inference regarding a plurality of data pieces contained in a section which is temporally continuous. In this calculation, for example, the calculating section 12 calculates the degree of agreement on the basis of whether the classes of highest scores in the results of the inference agree with each other.

In step S13, the pseudo label assigning section 13 assigns a pseudo label based on the results of inference in the section, to at least one of the plurality of data pieces in the section, according to the degree of agreement. In this assignment, the pseudo label assigning section 13 assigns a pseudo label to a data piece group having the results of inference the degree of agreement among which is judged to satisfy a predetermined condition.

In this manner, the information processing is carried out. This information processing manner provides, for example, the time-series data SD after the pseudo label assignment as illustrated in FIG. 2.

### <Example Advantage of Information Processing Apparatus 1 and Information Processing Method>

With the information processing apparatus 1 and the information processing method S1 in accordance with the present example embodiment, a class regarding each of data pieces which constitute time-series data is inferred, the degree of agreement among the results of inference regarding a plurality of data pieces contained in a section which is temporally continuous is calculated, and a pseudo label based on the results of inference in the section is assigned to at least one of the plurality of data pieces in the section, according to the degree of agreement.

With this configuration, it is possible to assign a pseudo label to the entire time-series data, even in a case where, for example, the time-series data has a section in which a class label is not assigned and which lasts for a long time. That is, with the information processing apparatus 1 and the information processing method S1 in accordance with the present example embodiment, it is possible to assign a pseudo label regardless of the presence or absence of class-labeled data.

### Second Example Embodiment

The following description will discuss a second example embodiment of the present invention in detail with reference to the drawings. Note that a component having the same function as a component described in the first example embodiment is assigned the same reference sign, and the description thereof is omitted where appropriate.

### <Configuration of Information Processing Apparatus 1A>

Here is a description of a configuration of an information processing apparatus 1A in accordance with the present example embodiment, provided with reference to the block diagram of FIG. 3.

As an example, the information processing apparatus 1A is used for behavior recognition processing in which when moving image data is inputted as time-series data, the action (e.g. walking, sitting, etc.) of the subject of each of the frames which constitute the moving images is inferred as a class. As another example, the information processing apparatus 1A is used for voice recognition in which when voice data is inputted as time-series data, the utterance (e.g. words, letters, etc.) at each time is inferred as a class.

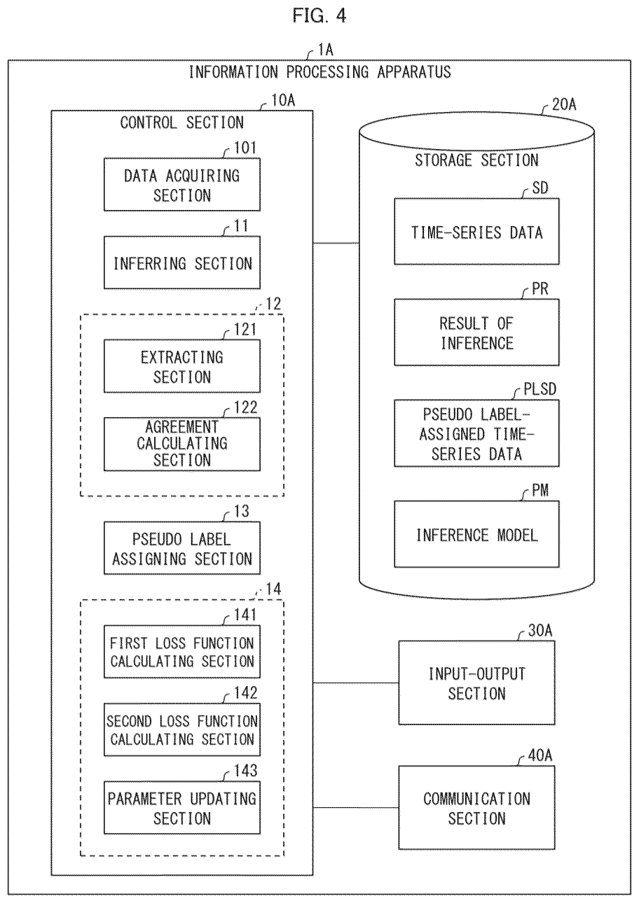

FIG. 4 is a block diagram for explaining an example of a functional configuration of the information processing apparatus 1A. The information processing apparatus 1A includes a control section 10A, a storage section 20A, an input section 30A, and a communication section 40A, as illustrated in FIG. 4.

The control section 10A is a functional block having the same function as the information processing apparatus 1 described in the first example embodiment. The control section 10A includes a data acquiring section 101, an inferring section 11, a calculating section 12, a pseudo label assigning section 13, and a training section 14.

The data acquiring section 101 acquires time-series data SD. The inferring section 11, the calculating section 12, and the pseudo label assigning section 13 each have the corresponding function described with reference to FIG. 1 and FIG. 2. However, in the example of FIG. 4, the calculating section 12 includes an extracting section 121 and an agreement calculating section 122.

The extracting section 121 extracts a data piece group in a section which is temporally continuous, from data pieces of the time-series data SD. For example, the extracting section 121 extracts a data piece group in a section which is temporally continuous, from the data piece PD01 to the data piece PD06 of FIG. 2.

The agreement calculating section 122 calculates the degree of agreement among the results of inference regarding the data pieces extracted. As described above, the result of inference is outputted as the degree of confidence in each of a plurality of classes regarding each of the data pieces. An example of the method for calculating the degree of agreement is as described in the first example embodiment.

The training section 14 is a functional block for training the inferring section 11 by updating parameters of an inference model. After the pseudo label assigning section 13 assigns a pseudo label to a data piece, the inferring section 11 may be trained by using, as labeled training data, time-series data having a pseudo label assigned thereto. In the example of FIG. 4, the training section 14 includes a first loss function calculating section 141, a second loss function calculating section 142, and a parameter updating section 143.

The first loss function calculating section 141 calculates a loss function necessary for training the inferring section 11 with use of a class label. The class label here represents the actual class of data. The class label indicates a class which serves as a ground truth in inferring the class of the data, and is not a pseudo label. The training of the inferring section 11 with use of this class label is carried out, for example, before the information processing of assigning a pseudo label is carried out in the information processing apparatus 1A.

The second loss function calculating section 142 calculates a loss function necessary for training the inferring section 11 with use of a pseudo label.

The parameter updating section 143 uses the loss function calculated by the first loss function calculating section 141 and the loss function calculated by the second loss function calculating section 142, to update model parameters of an inference model.

That is, the training section 14 is capable of training the inferring section 11 with use of time-series data to which a class label which serves as a ground truth is assigned in advance. The training section 14 is also capable of training the inferring section 11 with use of time-series data which contains a pseudo label assigned by the pseudo label assigning section.

A storage section 40 is composed by, for example, a semiconductor memory device, and stores data. In this example, the storage section 40 has stored therein the time-series data SD, results of inference PR, pseudo label-assigned time-series data PLSD, and an inference model PM.

The time-series data SD, the results of inference PR, and the pseudo label-assigned time-series data PLSD correspond respectively to the time-series data SD, the results of inference PR, and the time-series data after pseudo label assignment, which are described with reference to FIG. 2. The pseudo label-assigned time-series data PLSD can be used as labeled training data at the time when training section 14 trains the inferring section 11.

The inference model PM is an inference model used by the inferring section 11 to infer the class of each data piece. More specifically, the inference model PM refers to model parameters of the inference model.

The input section 30A accepts various inputs to the information processing apparatus 1A. A specific configuration of the input section 30A does not limit the present example embodiment, and is, for example, the configuration in which an input device such as a keyboard or a touch pad is included. In addition, the configuration of the input section 30A may be such that a data scanner for reading data via electromagnetic waves such as infrared rays and radio waves, a sensor for sensing the state of an environment, and the like are included.

The communication section 40A is an interface via which the information processing apparatus 1A is connected to a network. A specific configuration of the network does not limit the present example embodiment, but examples of the network that can be used include a wireless local area network (LAN), a wired LAN, a wide area network (WAN), a public network, a mobile data communication network, and a combination thereof.

### <Flow of Information Processing Method S1A Carried Out by Information Processing Apparatus 1A>

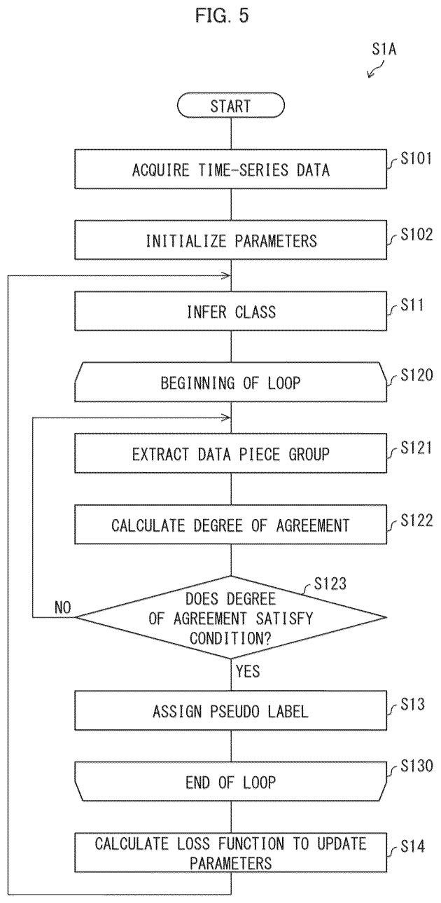

Described next is a flow of an information processing method S1A carried out by the information processing apparatus 1A, with reference to the flowchart of FIG. 5. Assume that in prior to this processing, the training of the inferring section 11 with use of a class label representing the actual class of data is carried out. Assume therefore that the inferring section 11 is capable of inferring the class of a data piece with use of parameters in an initial state (initialized parameters).

In step S101, the data acquiring section 101 acquires time-series data SD. In this acquisition, for example, the time-series data SD stored in the storage section 40 is acquired by the data acquiring section 101.

In step S102, the inferring section 11 initializes parameters. Initialized in this initialization is, for example, model parameters (inference model PM) of an inference model used at the time when the inferring section 11 infers the class of each data piece, the model parameters being stored in the storage section 40.

In step S11, the inferring section 11 infers the class of a data piece. This process corresponds to step S11 in the flowchart of FIG. 3. In this inference, the inferring section 11 infers the class of a data piece with use of the inference model PM.

The processes of step S120 to step S130 are loop processes repeatedly carried out until it is judged that there is no data piece group to be extracted from the time-series data SD acquired in step S101.

In step S121, the extracting section 121 extracts a data piece group from the time-series data SD acquired in step S101. For example, the extracting section 121 extracts the data piece group (data piece PD02 to data piece PD04) in the section which is temporally continuous, as described with reference to FIG. 2. Note that the data piece group extracted by this extraction has not been assigned a class label yet.

In step S122, the agreement calculating section 122 calculates the degree of agreement among the results of inference regarding the data pieces extracted in step S121.

In step S123, the pseudo label assigning section 13 judges whether the degree of agreement calculated in step S122 satisfies a predetermined condition. In a case where it is judged that the condition is not satisfied in step S123, the processing returns to step S121. In a case where it is judged that the condition is satisfied in step S123, the processing proceeds to step S13.

In step S13, the pseudo label assigning section 13 assigns a pseudo label to a data piece. This process corresponds to step S11 in the flowchart of FIG. 3.

Upon the end of the loop processes of step S120 to step S130, pseudo label-assigned time-series data is obtained, and the processing proceeds to step S14.

In step S14, the training section 14 calculates a loss function, to update the parameters. In this calculation, the inference model PM stored in the storage section 40 is updated. Note that in the flowchart of FIG. 5, the training of the inference model with use of a pseudo label is assumed. In step S14, the parameter updating section 143 uses the loss function calculated by the second loss function calculating section 142, to update the inference model PM.

After that, the processing returns to step S11, and the processes of step S11 and subsequent steps are repeatedly carried out. In this manner, the information processing carried out by the information processing apparatus 1A is carried out.

### (Calculation of Degree of Agreement and Specific Example of Condition)

Described next is the degree of agreement calculated in step S122 and a specific example of the condition used for the judgment in step S123.

### Specific Example 1

With the method for calculating the degree of agreement described in the first example embodiment, the proportion of data pieces in a data piece group is calculated, the data pieces having classes of highest scores in the results of inference, the classes of highest scores agreeing with each other. That is, the inferring section 11 calculates the degrees of confidence in each of a plurality of classes regarding each data piece, and in a case where the sameness of the classes of highest degrees of confidence regarding a plurality of data pieces contained in a section is not smaller than a predetermined proportion, the pseudo label assigning section 13 assigns a pseudo label based on the results of inference in the section, to at least one of the plurality of data pieces in the section. The predetermined proportion here can be, for example, not less than 80%.

For example, given that the results of inference at times i and j in a section which is temporally continuous are represented as pi and pj, the agreement calculating section 122 can calculate the degree of agreement between times i and j by the following expression.

$$\begin{matrix}C\_ij = 1 ( if arg max ( pi ) == arg max ( pj ) ) \\ = 0 ( else )\end{matrix}$$

In a case where not less than 80% of any combinations of times i and j in the section satisfy C_ij>=1, the pseudo label assigning section 13 assigns a pseudo label to the data pieces of the data piece group.

Further, all of the plurality of data pieces may be assigned a pseudo label. That is, in a case where the sameness of the classes of highest degrees of confidence regarding the plurality of data pieces contained in the section is not smaller than a predetermined proportion, the pseudo label assigning section 13 may assign a pseudo label based on the results of inference in the section, to all of the plurality of data pieces in the section.

Alternatively, the inferring section 11 calculates the degree of confidence in each of the plurality of classes regarding each data piece, and in a case where the distance between distributions of the degrees of confidence regarding the plurality of data pieces contained in the section is not greater than a predetermined value, the pseudo label assigning section 13 may assign a pseudo label based on the results of inference in the section, to at least one of the plurality of data pieces in the section.

In this case, the distributions of the degrees of confidence in the plurality of respective classes are further calculated regarding the plurality of data pieces contained in the section, and the distance between distributions is calculated with respect to these distributions. As an example, the distance between distributions is calculated as the Kullback-Leibler information (K-L divergence).

In a case where the distributions of the degrees of confidence in the plurality of respective classes are similar to each other, those data pieces are considered similar to each other, and the pseudo label assigning section 13 assigns a pseudo label based on the results of inference in the section.

### Specific Example 2

Although a pseudo label is assigned in a case where the sameness of the classes of highest degrees of confidence is not smaller than a predetermined proportion in the specific example 1, a pseudo label may be assigned in a case where the classes of highest degrees of confidence in the results of inference regarding all the data pieces are the same. In this case, the agreement calculating section 122 calculates the degree of agreement as in the specific example 1, and in addition, the threshold used for the conditional judgment is set to a high value (e.g. not less than 1). This makes it possible to assign a more highly reliable pseudo label.

That is, in a case where all the classes of highest degrees of confidence are the same regarding the plurality of data pieces contained in the section, the pseudo label assigning section 13 may assign a pseudo label based on the results of inference in the section, to all of the plurality of data pieces in the section.

### Specific Example 3

In a case where the classes of highest degrees of confidence (scores) are the same but the scores greatly differ from each other in the results of inference of the respective data pieces, the features of the respective data pieces are highly likely to greatly differ from each other, for example. In such a case, it cannot necessarily be said that the sameness of the classes of the respective data pieces is high.

Therefore, for example, in a case where the scores in the results of inference of respective data pieces are compared with each other, and the difference between the scores does not greatly differ, a pseudo label may be assigned.

For example, the data piece PD02 to the data piece PD04 contained in the data piece group of FIG. 2 have the classes of highest scores which are the same class (CL1), and the respective scores are 0.90, 0.86, and 0.92. For example, among these scores, the highest score “0.92” and the lowest score “0.86” are compared with each other, and the amount of difference between the highest and lowest scores is calculated. The amount of difference can be calculated by the agreement calculating section 122 on the basis of, for example, the difference, the ratio, etc. between both scores. In a case where, for example, the difference between both scores is such that a greater one of both scores is not greater than two times the other, the pseudo label assigning section 13 judges that the scores do not greatly differ from each other. In this case, a pair of the data piece PD03 and the data piece PD04 are judged in terms of whether the difference between the scores of CL1 of the pair is such that a greater one of the scores is not greater than two times the other.

Note that “not greater than two times” is presented by way of example. In a case where, for example, the difference between the scores is such that a greater one of the scores is not greater than three times (or four times) the other, it may be judged that the scores do not greatly differ from each other. That is, in a case where the classes of highest degrees of confidence regarding any pair of data pieces of a plurality of data pieces contained in a section are the same, and the difference between the highest degrees of confidence is such that a greater one of the highest degrees of confidence is not greater than any constant number of times the other, the pseudo label assigning section 13 may assign a pseudo label based on the results of inference in the section, to at least one of the plurality of data pieces in the section.

For example, given that the results of inference at times i and j in a section which is temporally continuous are represented as pi and pj, the agreement calculating section 122 can calculate the degree of agreement between times i and j by the following expression.

C_ij=max(|max(p_i)/max(p_j)|,|max(p_j)/max(p_i)|)

In a case where, for example, C_ij<=2.0 is satisfied for any times i and j in the section, the pseudo label assigning section 13 assigns a pseudo label to a data piece of the data piece group.

### Specific Example 4

Alternatively, in a case where the variance (dispersion) in the scores in the results of inference among data pieces is low, it may be judged that the scores do not greatly differ from each other. For example, the agreement calculating section 122 calculates the degree of CL1 score variance with respect to the results of inference of the data piece PD02 to the data piece PD04 contained in the data piece group of FIG. 2. The degree of CL1 score variance is the degree of agreement. In a case where the degree of agreement (i.e. the degree of variance) is smaller than a threshold, the pseudo label assigning section 13 may assign a pseudo label.

In a case where, for example, the time-series data SD is moving image data, since the data piece PD02 to the data piece PD04 are frames in a section which is temporally continuous, a person who is the subject is highly likely to be acting the same in the data pieces. However, when there is dispersion in the scores in the results of inference made regarding the frames of the section which is temporally continuous, it is highly likely that the results of inference are not correct.

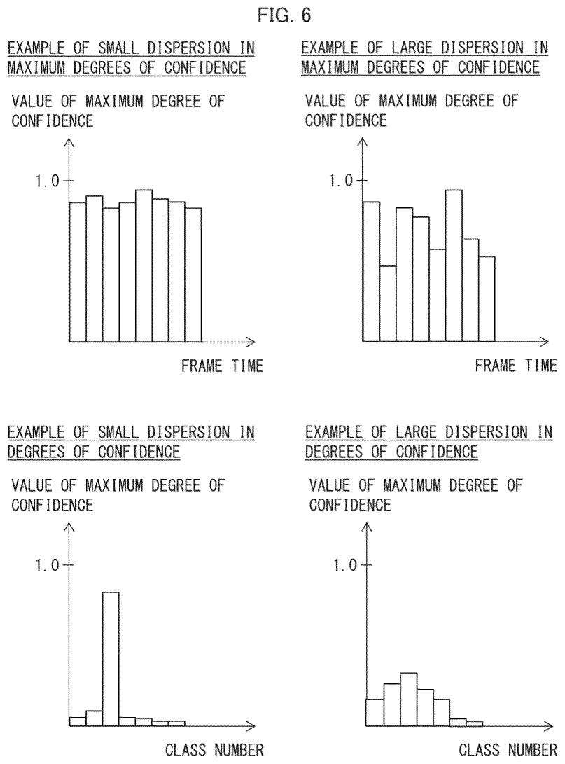

FIG. 6 is a representation for explaining the dispersion in the highest degrees of confidence (maximum degrees of confidence) in the results of inference of data pieces. Two graphs in the upper part of FIG. 6 represent the dispersion in the maximum degrees of confidence along a time axis. In the two graphs in the upper part of FIG. 6, the horizontal axis represents a frame time, and the vertical axis represents the value of the maximum degree of confidence. In the graph on the left, the value of the maximum degree of confidence is approximately constant on the time axis, and the dispersion in the maximum degrees of confidence is thus small. In the graph on the right, the value of the maximum degree of confidence varies along the time axis, and the dispersion in the maximum degrees of confidence is thus large.

The pseudo label assigning section 13 may assign, according to the dispersion, along a time axis, in the highest degrees of confidence in a plurality of respective data pieces contained in a section, a pseudo label based on the results of inference in the section, to at least one of the plurality of data pieces in the section.

### Specific Example 5

Alternatively, in a case where whether the variance (dispersion) in scores which are in the results of inference and which are of respective classes is large in data pieces in a section which is temporally continuous is judged, and it is judged that the variance is not large, a pseudo label may be assigned.

In the example described with reference to FIG. 2, the results of inference contain the scores corresponding to the respective classes, CL1, CL2, and CL3. In such a situation, when the score of any one of the classes is exceptionally high, and the scores of the others are low, it can be said that the results of inference is highly likely to be correct. Conversely, when the score of any one of the classes is not exceptionally high, the possibility that the results of inference is correct decreases.

The two graphs in the lower part of FIG. 6 are graphs for explaining the dispersion in the degrees of confidence of the respective classes in the result of inference regarding a data piece of the data piece group extracted by the extracting section 121. Two graphs on the lower part of FIG. 6, the horizontal axis represents a class number (e.g. CL1, CL2, CL3, . . . ), and the vertical axis represents the value of the maximum degree of confidence. In the left graph of the two graphs in the lower part of FIG. 6, the maximum degree of confidence is exceptionally high as compared with the other degrees of confidence, and the dispersion in the degrees of confidence of the respective classes is small. Conversely, in the right graph, it cannot be said that the maximum degree of confidence is exceptionally high as compared with the other degrees of confidence, and the dispersion in the degrees of confidence of the respective classes is large.

In this case, for example, the degree of variance in the degrees of confidence contained in the result of inference of the data piece is calculated, as the degree of agreement, by the agreement calculating section 122. Further, in a case where the degree of agreement (i.e. the degree of variance) is smaller than a threshold, a pseudo label may be assigned by the pseudo label assigning section 13.

That is, the pseudo label assigning section 13 may assign, according to the dispersion in the degrees of confidence of at least one of a plurality of data pieces contained in a section, the degrees of confidence being of respective classes in the at least one of the plurality of data pieces, a pseudo label based on the results of inference in the section, to the at least one of the plurality of data pieces in the section.

### Specific Example 6

Examples described in the above specific example 1 to specific example 5 are the examples in which in a case where the degree of agreement calculated satisfies a predetermined condition, a pseudo label is assigned to at least one of a plurality of data pieces in a section or all of the plurality of data pieces in the section. However, among the data piece group which refers to a plurality of data pieces in a section, one specified data piece may be assigned a pseudo label. Hereinafter, the one specified data piece is referred to as a target data piece.

For example, with respect to a data piece group containing a target data piece, the calculations of the degree of agreement described in the specific example 1 to the specific example 5 are performed, and in a case where it is judged that a condition is satisfied, a pseudo label may be assigned only to the target data piece. The target data piece may be a data piece located at the center of a section which is temporally continuous and which corresponds to the data piece group, or may be a data piece at a position which is the earliest or latest in terms of time. That is, the position of the target data piece in a section which is temporally continuous and which corresponds to a data piece group is any position.

Furthermore, the length of the data piece group containing the target data piece may vary according to the results of inference regarding the target data piece. For example, in a case where the class of the highest degree of confidence of the target data piece is class A, three frames close to the target data piece constitute the data piece group. In a case where the class of the highest degree of confidence of the target data piece is class B, ten frames close to the target data piece may constitute the data piece group.

While a section which is temporally continuous and which corresponds to a data piece group extracted by the extracting section 121 is thus changed in accordance with the target data piece, pseudo label assignment may be carried out.

### <Example Advantage if Information Processing Apparatus 1A and Information Processing Method S1A>

With the information processing apparatus 1A and the information processing method S1A in accordance with the present example embodiment, it is possible to assign a pseudo label to the entire time-series data, even in a case where, for example, the time-series data has a section in which a class label is not assigned and which lasts for a long time. That is, with the information processing apparatus 1A and the information processing method S1A in accordance with the present example embodiment, it is possible to assign a pseudo label regardless of the presence or absence of class-labeled data.

In addition, by appropriately making the calculation and condition of the degree of agreement concrete, it is possible to implement pseudo label assignment according to the properties of time-series data. For example, it is possible to appropriately assign, to time-series data which is moving image data, a pseudo label according to differing properties of the time-series data, such as the cases of a big motion, a small motion, a quick motion, and a slow motion of the subject.

Further, it is possible to also use, as labeled training data, data close in time to data not having a label assigned thereto, to perform training, and it is also possible to further increase inference accuracy.

### Third Example Embodiment

The following description will discuss a third example embodiment of the present invention in detail with reference to the drawings. Note that a component having the same function as a component described in the first example embodiment or the second example embodiment is assigned the same reference sign, and the description thereof is omitted where appropriate.

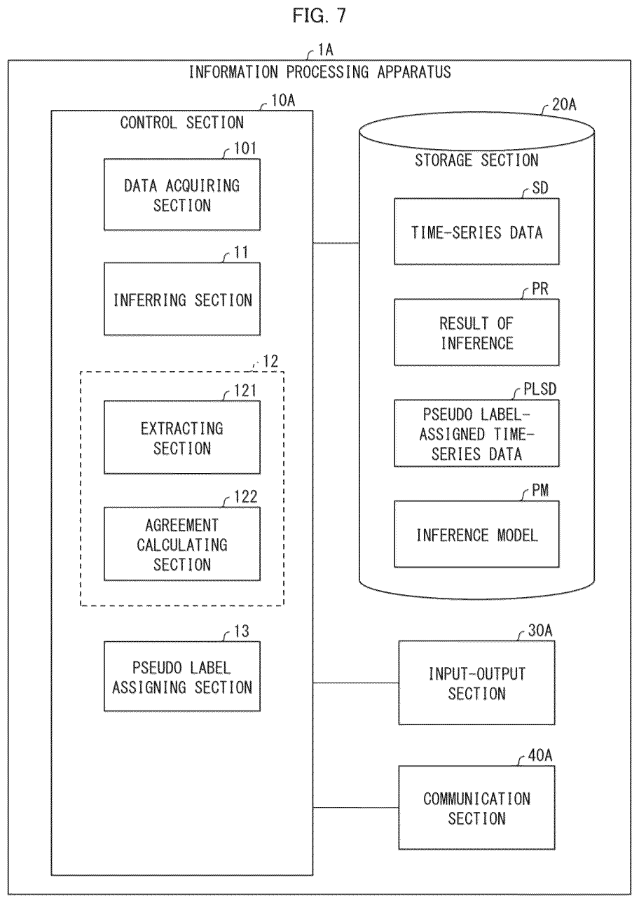

FIG. 7 is a block diagram illustrating an example configuration of an information processing apparatus 1A in accordance with the third example embodiment. Unlike the information processing apparatus 1A of FIG. 4, the information processing apparatus 1A of FIG. 7 does not have a training section 14 provided in a control section 10A. The other components are the same as in the example configuration illustrated in FIG. 4, and the detailed descriptions thereof are therefore omitted.

The information processing apparatus 1A of FIG. 7 does not have the function of training an inferring section 11, but generates pseudo label-assigned time-series data PLSD. As described above, in the information processing apparatus 1A of FIG. 4, it is possible for the training section 14 to train the inferring section 11, by using the pseudo label-assigned time-series data PLSD as labeled training data.

The information processing apparatus 1A of FIG. 7 supplies the generated pseudo label-assigned time-series data PLSD to an additional information processing apparatus (e.g. the information processing apparatus 1A illustrated in FIG. 4). With this, the additional information processing apparatus uses the supplied pseudo label-assigned time-series data PLSD as labeled training data, to train the inferring section 11. At the same time, in the additional information processing apparatus, carrying out processes involved in assigning a pseudo label to time-series data SD can be omitted.

### Example Advantage of Third Example Embodiment

As above, with the information processing apparatus 1A in accordance with the present example embodiment, it is possible to generate pseudo label-assigned time-series data, the time-series data being used by an additional information processing apparatus as labeled training data.

### [Software Implementation Example]

Some or all of the functions of each of the information processing apparatuses 1 and 1A may be implemented by hardware such as an integrated circuit (IC chip), or may be implemented by software.

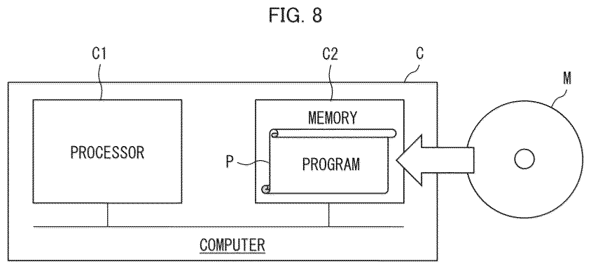

In the latter case, the information processing apparatuses 1 and 1A are provided by, for example, a computer that executes instructions of a program that is software implementing the foregoing functions. An example (hereinafter, computer C) of such a computer is illustrated in FIG. 8.

The computer C includes at least one processor C1 and at least one memory C2. The memory C2 has recorded thereon a program P for causing the computer C to operate as the information processing apparatuses 1 and 1A. The processor C1 of the computer C retrieves the program P from the memory C2 and executes the program P, so that the functions of the information processing apparatuses 1 and 1A are implemented.

Examples of the at least one processor C1 can include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be recorded on a non-transitory, tangible recording medium M capable of being read by the computer C. Examples of such a recording medium M can include a tape, a disk, a card, a semiconductor memory, and a programmable logic circuit. The computer C can obtain the program P via such a recording medium M. The program P can be transmitted via a transmission medium. Examples of such a transmission medium can include a communication network and a broadcast wave. The computer C can also obtain the program P via such a transmission medium.

### [Additional Remark 1]

The present invention is not limited to the above example embodiments, but may be altered in various ways by a skilled person within the scope of the claims. For example, the present invention also encompasses, in its technical scope, any example embodiment derived by appropriately combining technical means disclosed in the above example embodiments.

### [Additional Remark 2]

The whole or part of the example embodiments disclosed above can be described as, but not limited to, the following supplementary notes.

### (Supplementary Note 1)

An information processing apparatus including:
an inferring means for inferring a class regarding each of data pieces which constitute time-series data;
a calculating means for calculating a degree of agreement among results of inference made by the inferring means regarding a plurality of data pieces contained in a section which is temporally continuous; and
a pseudo label assigning means for assigning a pseudo label based on the results of inference in the section, to at least one of the plurality of data pieces in the section, according to the degree of agreement.

### (Supplementary Note 2)

The information processing apparatus described in supplementary note 1, in which
the inferring means is configured to calculate a degree of confidence in each of a plurality of classes regarding each of the data pieces, and
the pseudo label assigning means is configured to
   in a case where a sameness of classes of highest degrees of confidence regarding the plurality of data pieces contained in the section is not smaller than a predetermined proportion, assign a pseudo label based on the results of inference in the section, to at least one of the plurality of data pieces in the section.

### (Supplementary Note 3)

The information processing apparatus described in supplementary note 2, in which
the pseudo label assigning means is configured to
   in a case where the sameness of classes of highest degrees of confidence regarding the plurality of data pieces contained in the section is not smaller than a predetermined proportion, assign a pseudo label based on the results of inference in the section, to all of the plurality of data pieces in the section.

### (Supplementary Note 4)

The information processing apparatus described in supplementary note 3, in which
the pseudo label assigning means is configured to
   in a case where all of classes of highest degrees of confidence regarding the plurality of data pieces contained in the section are the same, assign a pseudo label based on the results of inference in the section, to all of the plurality of data pieces in the section.

### (Supplementary Note 5)

The information processing apparatus described in supplementary note 1, in which
the pseudo label assigning means is configured to
   in a case where classes of highest degrees of confidence regarding any pair of data pieces of the plurality of data pieces in the section are the same, and a difference between the highest degrees of confidence is such that a greater one of the highest degrees of confidence is not greater than two times the other, assign a pseudo label based on the results of inference in the section, to at least one of the plurality of data pieces in the section.

### (Supplementary Note 6)

The information processing apparatus described in supplementary note 1, in which
the pseudo label assigning means is configured to
   according to dispersion, along a time axis, in highest degrees of confidence in the plurality of respective data pieces contained in the section, assign a pseudo label based on the results of inference in the section, to at least one of the plurality of data pieces in the section.

### (Supplementary Note 7)

The information processing apparatus described in supplementary note 1, in which
the pseudo label assigning means is configured to
   according to dispersion in degrees of confidence of at least one of the plurality of data pieces contained in the section, the degrees of confidence being of respective classes in the at least one of the plurality of data pieces, assign a pseudo label based on the results of inference in the section, to the at least one of the plurality of data pieces in the section.

### (Supplementary Note 8)

The information processing apparatus described in supplementary note 1, in which
the inferring means is configured to calculate a degree of confidence in each of a plurality of classes regarding each of the data pieces, and
the pseudo label assigning means is configured to
   in a case where a distance between distributions of degrees of confidence regarding the plurality of data pieces contained in the section is not greater than a predetermined value, assign a pseudo label based on the results of inference in the section, to at least one of the plurality of data pieces in the section.

### (Supplementary Note 9)

The information processing apparatus described in any one of supplementary notes 1 to 8, further including
a training means for training the inferring means with use of time-series data which contains a pseudo label assigned by the pseudo label assigning means.

### (Supplementary Note 10)

An information processing method including:
inferring a class regarding each of data pieces which constitute time-series data;
calculating a degree of agreement among results of inference regarding a plurality of data pieces which are contained in a section which is temporally continuous; and
assigning a pseudo label based on the results of inference in the section, to at least one of the plurality of data pieces in the section, according to the degree of agreement.

### (Supplementary Note 11)

A program for causing a computer to function as an information processing apparatus including:
an inferring means for inferring a class regarding each of data pieces which constitute time-series data;
a calculating means for calculating a degree of agreement among results of inference made by the inferring means regarding a plurality of data pieces contained in a section which is temporally continuous; and
a pseudo label assigning means for assigning a pseudo label based on the results of inference in the section, to at least one of the plurality of data pieces in the section, according to the degree of agreement.

### [Additional Remark 3]

The whole or part of the example embodiments disclosed above can be described as follows.

At least one processor is included, the at least one processor carrying out:
a process of inferring a class regarding each of data pieces which constitute time-series data;
a process of calculating a degree of agreement among results of inference regarding a plurality of data pieces contained in a section which is temporally continuous; and
a process of assigning a pseudo label based on the results of inference in the section, to at least one of the plurality of data pieces in the section, according to the degree of agreement.

This information processing apparatus may further include a memory, and this memory may have stored therein a program for causing the at least one processor to carry out the process of inferring a class, the process of calculating a degree of agreement, and the process of assigning a pseudo label. A computer-readable, non-transitory, and tangible recording medium may have this program recorded thereon.

### REFERENCE SIGNS LIST

1: Information processing apparatus
10A: Control section
11: Inferring section
12: Calculating section
13: Pseudo label assigning section
14: Training section
20A: Storage section
30A: Input section
40A: Communicating section
121: Extracting section
122: Agreement calculating section
141: First loss function calculating section
142: Second loss function calculating section
143: Parameter updating section

What is claimed is:

1. An information processing apparatus comprising at least one processor, the at least one processor carrying out:
an inferring process of inferring a class regarding each of data pieces which constitute time-series data;
a calculating process of calculating a degree of agreement among results of inference made by the inferring process regarding a plurality of data pieces contained in a section which is temporally continuous; and
a pseudo label assigning process of assigning a pseudo label based on the results of inference in the section, to at least one of the plurality of data pieces in the section, according to the degree of agreement.

2. The information processing apparatus according to claim 1, wherein
in the inferring process, a degree of confidence in each of a plurality of classes regarding each of the data pieces is calculated, and
in the pseudo label assigning process,
in a case where a sameness of classes of highest degrees of confidence regarding the plurality of data pieces contained in the section is not smaller than a predetermined proportion, a pseudo label based on the results of inference in the section; is assigned to at least one of the plurality of data pieces in the section.

3. The information processing apparatus according to claim 2, wherein
in the pseudo label assigning process,
in a case where the sameness of classes of highest degrees of confidence regarding the plurality of data pieces contained in the section is not smaller than a predetermined proportion, a pseudo label based on the results of inference in the section, is assigned to all of the plurality of data pieces in the section.

4. The information processing apparatus according to claim 3, wherein
in the pseudo label assigning process,
in a case where all of classes of highest degrees of confidence regarding the plurality of data pieces contained in the section are the same, a pseudo label based on the results of inference in the section is assigned to all of the plurality of data pieces in the section.

5. The information processing apparatus according to claim 1, wherein
in the pseudo label assigning process,
in a case where classes of highest degrees of confidence regarding any pair of data pieces of the plurality of data pieces in the section are the same, and a difference between the highest degrees of confidence is such that a greater one of the highest degrees of confidence is not greater than any constant number of times the other, a pseudo label based on the results of inference in the section is assigned to at least one of the plurality of data pieces in the section.

6. The information processing apparatus according to claim 1, wherein
in the pseudo label assigning process,
according to dispersion, along a time axis, in highest degrees of confidence in the plurality of respective data pieces contained in the section, a pseudo label based on the results of inference in the section is assigned to at least one of the plurality of data pieces in the section.

7. The information processing apparatus according to claim 1, wherein
in the pseudo label assigning process,
according to dispersion in degrees of confidence of at least one of the plurality of data pieces contained in the section, the degrees of confidence being of respective classes in the at least one of the plurality of data pieces, a pseudo label based on the results of inference in the section is assigned to the at least one of the plurality of data pieces in the section.

8. The information processing apparatus according to claim 1, wherein
in the inferring process, a degree of confidence in each of a plurality of classes regarding each of the data pieces is calculated, and
in the pseudo label assigning process,
in a case where a distance between distributions of degrees of confidence regarding the plurality of data pieces contained in the section is not greater than a predetermined value, a pseudo label based on the results of inference in the section is assigned to at least one of the plurality of data pieces in the section.

9. The information processing apparatus according to claim 1, the at least one processor further carries out
a training process for training an inferring means with use of time-series data which contains a pseudo label assigned by the pseudo label assigning process, the inferring means carrying out the inferring process.

10. An information processing method comprising:
inferring a class regarding each of data pieces which constitute time-series data;
calculating a degree of agreement among results of inference regarding a plurality of data pieces which are contained in a section which is temporally continuous; and
assigning a pseudo label based on the results of inference in the section, to at least one of the plurality of data pieces in the section, according to the degree of agreement.

11. A non-transitory storage medium storing a program for causing a computer to carry out:
an inferring process of inferring a class regarding each of data pieces which constitute time-series data;
a calculating process of calculating a degree of agreement among results of inference made by the inferring process regarding a plurality of data pieces contained in a section which is temporally continuous; and
a pseudo label assigning process of assigning a pseudo label based on the results of inference in the section, to at least one of the plurality of data pieces in the section, according to the degree of agreement.
